(19) United States
(12) Patent Application Publication
(10) Pub. No.: US 2009/0021681 A1
(43) Pub. Date: Jan. 22, 2009

(54) DISPLAY PANEL ASSEMBLY, MANUFACTURING METHOD THEREOF, AND DISPLAY DEVICE INCLUDING THE SAME

(76) Inventors: Yong-kuk YUN, Gyeonggi-do (KR); Jeong-uk Heo, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 12/044,730

(22) Filed: Mar. 7, 2008

(30) Foreign Application Priority Data
Jul. 20, 2007 (KR) 10-2007-0073079

(51) Int. Cl. G02F 1/1337; G02F 1/1333; G02F 1/1339

(52) U.S. Cl. 349/128; 445/25; 349/153

(57) ABSTRACT

A manufacturing method of a display panel assembly, includes: preparing a first panel and a second panel each having a display area and a non-display area; forming a first alignment layer and a second alignment layer on the first panel and the second panel, respectively; eliminating at least a part of the first alignment layer and the second alignment layer which is disposed on the non-display area; forming a sealant on the non-display area of at least one of the first panel and the second panel; and adhering the first panel and the second panel each other with the first alignment layer and the second alignment layer facing each other.

### CROSS-REFERENCE TO RELATED APPLICATIONS

This application claims priority from Korean Patent Application No. 10-2007-0073079, filed on Jul. 20, 2007 in the Korean Intellectual Property Office, the disclosure of which is incorporated herein by reference.

### BACKGROUND OF INVENTION

1. Field of Invention

Apparatus and methods consistent with the present invention relate a display device having a panel assembly which has a minimized non-display area in comparison with a display area, and a manufacturing method therefor.

2. Description of Related Art

LCD device has the advantages of small size, light weight and low power consumption, and so on. The LCD device has been popular as a means to replace a conventional cathode ray tube. The LCD device is employed for not only a small-sized product such as a cellular phone, a personal digital assistance (PDA), or the like, but also a medium-sized or large-sized product such as a monitor, a television, etc. Further, the LCD device may also be employed for an extra large-sized product such as an outdoor electric board, a movable board, etc.

The LCD device generally includes a display panel assembly to display a video image, and a back light unit to supply light to the display panel assembly. The display panel assembly has a display area through which an image is substantially displayed, and a non-display area around the display area. On the non-display area is formed a sealant to adhere a pair of panels each other and is mounted a drive printed circuit board. However, if the non-display area becomes large, it is difficult to realize a slim-sized LCD device.

Particularly, in the case of an LCD device including a plurality of display panel assemblies which are adjacently arranged to display an extra large-sized image, there is a problem that the video image is discontinuous at a boundary between the display panel assemblies to thereby lower the precision and completeness of the image. The problem becomes more noticeable as the non-display area becomes large.

### SUMMARY OF INVENTION

Accordingly, it is an aspect of the present invention to provide a manufacturing method for a display panel assembly which can minimize the size of a non-display area in comparison with a display area.

The foregoing and/or other aspects of the present invention can be achieved by providing a manufacturing method of a display panel assembly, including: preparing a first panel and a second panel each having a display area and a non-display area; forming a first alignment layer and a second alignment layer on the first panel and the second panel, respectively; eliminating at least a part of the first alignment layer and the second alignment layer which is disposed on the non-display area; forming a sealant on the non-display area of at least one of the first panel and the second panel; and adhering the first panel and the second panel each other with the first alignment layer and the second alignment layer facing each other.

According to an aspect of the invention, the sealant is spaced from the first alignment layer and the second alignment layer.

According to an aspect of the invention, the sealant has a width of 0.5-1.5 mm.

According to an aspect of the invention, the sealant is spaced from the display area by a distance 0.1-1.0 mm.

According to an aspect of the invention, the sealant is spaced from relatively close one of an edge of the first panel and an edge of the second panel by a distance 0.1-0.3 mm.

According to an aspect of the invention, the sealant is spaced from relatively distant one of the edge of the first panel and the edge of the second panel by a distance 1.0-1.5 mm.

According to an aspect of the invention, the first alignment layer and the second alignment layer are eliminated using a spot-etching atmospheric plasma device.

According to an aspect of the invention, substantially all the first alignment layer and the second alignment layer are eliminated from the non-display area.

According to an aspect of the invention, the sealant includes a conductive material.

The foregoing and/or other aspects of the present invention can be achieved by providing a display panel assembly which has a display area and a non-display area around the display, including: a first panel which includes a thin film transistor and a pixel electrode; a second panel which includes a common electrode and is arranged opposite to the first panel; a first alignment layer which is formed on a surface of the first panel facing the second panel; a second alignment layer which is formed on a surface of the second panel facing the first panel; a liquid crystal layer which is disposed between the first panel and the second panel; and a sealant which is arranged on the non-display area to surround the display area and adheres the first panel and the second panel each other, wherein at least a part of the first alignment layer and the second alignment layer is eliminated from the non-display area.

According to an aspect of the invention, the sealant includes a conductive ball, and the sealant is electrically connected with the common electrode of the second panel.

The foregoing and/or other aspects of the present invention can be achieved by providing a display device including: a plurality of display panel assemblies each having a display area through which an image is displayed and a non-display area around the display area; and a support which supports the plurality of display panel assemblies to be aligned and connected each other, wherein each display panel assembly including: a first panel which includes a thin film transistor and a pixel electrode; a second panel which includes a common electrode and is arranged opposite to the first panel; a first alignment layer which is formed on a surface of the first panel facing the second panel; a second alignment layer which is formed on a surface of the second panel facing the first panel; an liquid crystal layer which is disposed between the first panel and the second panel; and a sealant which is arranged on the non-display area to surround the display area and adheres the first panel and the second panel each other, wherein at least a part of the first alignment layer and the second alignment layer is eliminated from the non-display.

### BRIEF DESCRIPTION OF DRAWINGS

The above and/or other aspects of the present invention will become apparent and more readily appreciated from the following description of the exemplary embodiments, taken in conjunction with the accompanying drawings, in which:

FIG. 1 is a section view illustrating a display panel assembly according to a first exemplary embodiment of the present invention;

FIG. 2 is an enlarged section view illustrating a part of the display panel assembly in FIG. 1;

FIGS. 3 through 7 are section views for sequentially illustrating a manufacturing method of a display panel assembly according to a second exemplary embodiment of the present invention; and

FIG. 8 is a front view illustrating a display device according to a third exemplary embodiment of the present invention.

### DETAILED DESCRIPTION

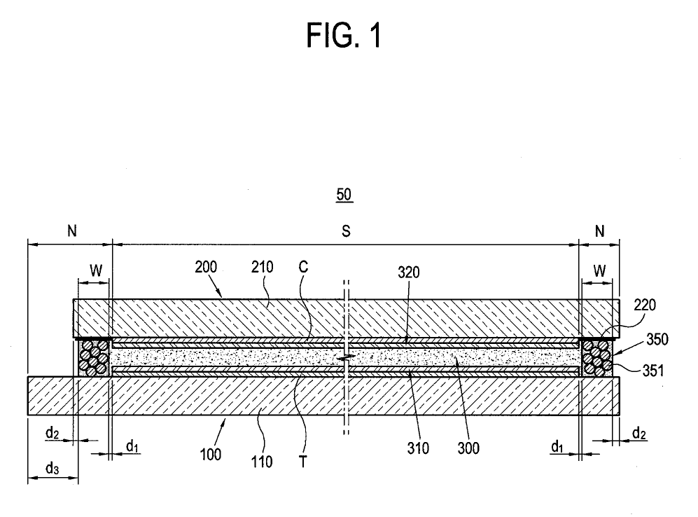

As shown in FIG. 1, a display panel assembly 50 according to a first exemplary embodiment of the present invention includes a first panel 100, a second panel 200, a first alignment layer 310, a second alignment layer 320, a liquid crystal layer 300 and a sealant 350.

The display panel assembly 50 has a display area S through which an image is displayed and a non-display area N around the display area through which the image is not displayed.

The first panel 100 includes a first substrate member 110 and a first thin film forming layer T which is formed on the first substrate member 110. The first thin film forming layer T includes a thin film transistor and a pixel electrode.

The second panel 200 is arranged opposite to the first panel 100. The second panel 200 includes a second substrate member 210 and a second thin film forming layer C which is formed on the second substrate member 210. The second thin film forming layer C is opposite to the first thin film forming layer T. The second thin film forming layer C includes a common electrode, a light blocking film and a color filter. Alternatively, the color filter and the light blocking film may be omitted as necessary. In this case, the color filter may be formed on the first thin film forming layer T. The light blocking film may be also formed on the non-display area N of the second panel 200.

The sealant 350 is disposed on the non-display area N and surrounds the display area S to sealingly adhere the first panel 100 and the second panel 200 to each other.

The first alignment layer 310 is formed on a surface of the first panel 100 which faces the second panel 200. That is, the first alignment layer 310 is formed on the first thin film forming layer T.

The second alignment layer 320 is formed on a surface of the second panel 200 which faces the first panel 200. That is, the second alignment layer 320 is formed on the second thin film forming layer C.

The first alignment layer T and the second alignment layer C may be formed of at least one of an organic material and an inorganic material.

The first alignment layer 310 and the second alignment layer 320 formed on the non-display area N are substantially eliminated during manufacturing process. That is, the first alignment layer 310 and the second alignment layer 320 are substantially formed only on the display area S. Accordingly, the first alignment layer 310 and the second alignment layer 320 formed on the display area S are separated from the sealant 350 formed on the non-display area N.

However, the present invention is not limited thereto. For example, a small part of the first alignment layer 310 and the second alignment layer 320 may be enter into the non-display area N. Thus, the first alignment layer 310 and the second alignment layer 320 may be separated from the sealant 350. If the sealant 350 overlaps the first alignment layer 310 and the second alignment layer 320, the adhesive force of the sealant 350 becomes weak, and thus, it is difficult to secure stable adhesion of the first panel 100 and the second panel 200. If the width of the sealant 350 is increased to overcome the adhesion problem, the non-display area N becomes larger than desirable.

The sealant 350 has a width W of 0.5-1.5 mm. If the width W of the sealant 350 is smaller than 0.5 mm, the first panel 100 and the second panel 200 can not be stably and sealingly adhered each other. To the contrary, if the width W of the sealant 350 is larger than 1.5 mm, an area of the sealant 350 becomes large, and thus, the non-display area N becomes larger than desirable.

The sealant 350 is spaced from the display area S by a distance d1 of 0.1-1.0 mm. If the distance d1 between the sealant 350 and the display area S is smaller than 0.1 mm, the sealant 350 may overlap the first alignment layer 310 and the second alignment layer 320 which are formed on the display area S. Also, it is desirable that the distance d1 is not less than 0.1 mm considering that the sealant 350 may enter into the display area S during the process of forming the sealant 350. To the contrary, if the distance d1 is larger than 1.0 mm, the non-display area N becomes larger than desirable.

The sealant 350 is spaced from relatively close one of an edge of the first panel 100 and an edge of the second panel 200 by a distance d2 of 0.1-0.3 mm, and from relatively distant one of the edge of the first panel 100 and the edge of the second panel 200 by a distance d3 of 1.0-1.5 mm.

In general, the edge of the second panel 200 which includes the common electrode is relatively close to the sealant 350. However, the edge of the first panel 100 may be relatively close to the sealant 350 as necessary.

If the distance d2 between the edge of the second panel 200 and the sealant 350 is smaller than 0.1mm, the sealant 350 may be damaged during the process of cutting the display panel assembly 50. To the contrary, if the distance d2 is larger than 0.3 mm, the non-display area N becomes larger than desirable.

On the edge of the first panel 100 is mounted a drive printed circuit board (not shown). If the distance d3 between the edge of the first panel 100 and the sealant 350 is smaller than 1.0 mm, it is difficult stably mount the drive printed circuit board on the edge of the first panel 100. To the contrary, if the distance d3 is larger than 1.5 mm, the non-display area becomes larger than desirable. The distance d3 between the edge of the first panel 100 and the sealant 350 may be substantially the same as the distance d2 between the edge of the second panel 200 and the sealant 350, in a part of the edge of the first panel 100 where the drive printed circuit board is not mounted. In this case, the distance d3 is 0.1-0.3 mm like the distance d2.

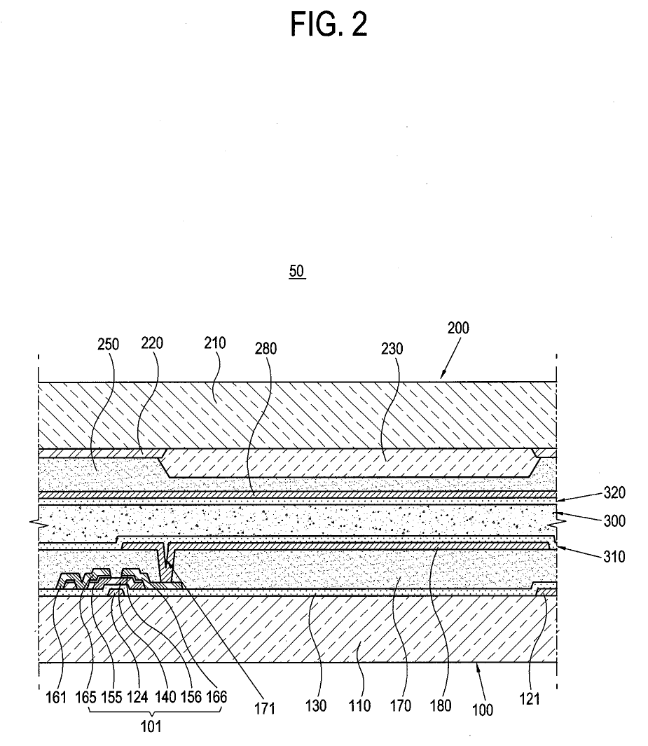

The sealant 350 is made of a conductive material. The sealant 350 may include a plurality of conductive balls. The sealant 350 is electrically connected with the common electrode 280 (see FIG. 2) of the second panel 200. That is, a common voltage is applied to the common electrode 280 through the sealant 350. Accordingly, an additional element to supply a common voltage to the common electrode 280 is unnecessary, which is otherwise necessary in a conventional display panel assembly. Thus, the non-display area N can be further minimized.

Specifically, the conductive sealant 350 can overlap a short point (not shown) formed on the second panel 200. The plurality of short points are provided to be spaced from each other along the edge of the second panel 200 and connected with the common electrode 280. The common voltage is applied to the common electrode 280 through the short points from the sealant 350.

The liquid crystal layer 300 may employ vertical alignment liquid crystal molecules or twisted nematic (TN) liquid crystal molecules according to a driving method thereof. Configuration of the first alignment layer 310 and the second alignment layer 320 may vary differently according to the type of the liquid crystal molecules in the liquid crystal layer 300.

When an electric field is formed between the pixel electrode of the first thin film forming layer T and the common electrode of the second thin film forming layer C, an alignment angle of the liquid crystal molecules in the liquid crystal layer 300 is changed to adjust light transmissivity. Thus, the display panel assembly 50 can realize a desired image.

As described above, the first alignment layer 310 and the second alignment layer 320 are eliminated from the non-display area N so that the sealant 350 can be disposed as close to the display area S as possible, and thus, the non-display area N necessary for the sealant 350 can be decreased. Also, the sealant 350 is made of a conductive material, and thus, an additional element for supplying the common voltage to the common electrode is unnecessary. With this configuration, the display panel assembly 50 can realize the non-display area N which is significantly minimized in size.

Hereinafter, an internal configuration of the display panel assembly 50 will be described centering on the display area S with reference to FIG. 2. In FIG. 2, there is shown the display panel assembly 50 which employs an amorphous silicon thin film transistor (a-Si TFT) formed by a five mask process, by way of example. However, the present invention is not limited thereto, but may be applied to various modifications.

Firstly, configuration of the first panel 100 will be described as follows.

The first substrate member 110 is transparently formed of material such as glass, quartz, ceramic, plastic, or the like.

On the first substrate member 110 is formed a gate wiring which includes a plurality of gate lines 121 and a plurality of gate electrodes 124 which is branched from the gate lines 121. Although not shown, the gate wiring may further include a first storage electrode line.

The gate wiring may be made of metal such as Al, Ag, Cr, Ti, Ta or Mo, or alloy thereof. Although the gate wiring is shown as a single-layer in FIG. 2, the gate wiring may be formed as a multi-layer including a first metal layer which is made of Cr, Mo, Ti or Ta, or alloy thereof having good physical-chemical characteristics and a second metal layer which is made of Al series metal or Ag series metal having low resistivity. Further, the gate wiring layer may be formed of various metals or conductive materials, and may be formed as any type of multi-layer to which patterning is possible under the same etching condition.

A gate insulating layer 130 which is made of silicon nitride (SiNx), etc. is formed on the gate wiring.

On the gate insulating layer 130 is formed a data wiring including a plurality of data lines 161 which cross the gate lines 121, a plurality of source electrodes 165 which are branched from the data lines 161, and a plurality of drain electrodes 166 which are spaced from the source electrodes 165. Although not shown, the data wiring may further include a second storage electrode line. The first and second storage electrode lines form electric capacitance.

The data wiring may be made of a conductive material such as Cr, Mo or Al, or alloy thereof, and may be formed as a single-layer or a multi-layer, like the gate wiring.

A semiconductor layer 140 is formed on a region of the gate insulating layer 130, over the gate electrode 124 and under the source electrode 165 and the drain electrode 166. Here, the gate electrode 124, the source electrode 165 and the drain electrode 166 forms three electrodes of a TFT 101. A region of the semiconductor layer 140 between the source electrode 165 and the drain electrode 166 functions as a channel region of the TFT 101.

Between the semiconductor layer 140 and the source electrode 165 and the drain electrode 166 are respectively formed ohmic contacts 155 and 156 to decrease resistance therebetween. The ohmic contacts 155 and 156 may be made of an amorphous silicon which is doped with a high concentration of N-impurities, etc.

On the data wiring is formed a passivation layer 170 which is formed of a low permittivity dielectric material such as a-Si:C:O or a-Si:O:F, or an inorganic dielectric material and formed by plasma-enhanced chemical vapor deposition (PECVD).

On the passivation layer 170 is formed a plurality of pixel electrodes 180. The pixel electrodes 180 include a transparent conductive material such as indium tin oxide (ITO) or indium zinc oxide (IZO).

The passivation layer 170 includes a plurality of contact holes 171 to expose a part of the drain electrode 166. The pixel electrode 180 and the source electrode 166 are connected each other through the contact holes 171.

The first thin film forming layer T as shown in FIG. 1 includes all the elements from the gate wiring to the pixel electrode 180 which are sequentially formed.

Next, configuration of the second panel 200 will be described as follows.

The second substrate member 210 is transparently formed of material such as glass, quartz, ceramic, plastic or the like, like the first substrate member 110.

On the second substrate member 210 is formed a light blocking film 220. The light blocking film 220 has an opening which faces the pixel electrode 180 of the first panel 100, and blocks light which is leaked between adjacent pixels. Here, a pixel represents a minimum unit to display an image. The light blocking film 220 is also formed on a corresponding region of the TFT 101 to block external light which enters into the semiconductor layer 140 of the TFT 101. Further, as shown in FIG. 1, the light blocking film 220 may be formed on the non-display area N to block light.

The light blocking film 220 may be formed of a photoresist material to which a black dye is added. The black dye may include carbon black or titanium oxide.

On the second substrate 210 on which the light blocking film 220 is formed, color filters 230 of three primary colors are sequentially arranged. The color filters 230 are not limited to three primary colors, but may be vary into one color or more as necessary.

The edge of each color filter 230 is disposed on the light blocking film 220, but alternatively, the respective edges of the adjacent color filters 230 may overlap with each other to perform a light blocking function. In this case, the light blocking films 220 around the edge of the pixels may be omitted.

On the light blocking film 220 and the color filter 230 may be formed an over coat 250, which may be omitted as necessary.

On the over coat 250 is formed the common electrode 280 which forms an electric field in cooperation with the pixel electrode 180. The common electrode 280 is formed of a transparent conductive material such as ITO or IZO, etc. The common electrode 280 is electrically connected to the sealant 350 (see FIG. 1) and is applied the common voltage.

The second thin film forming layer C in FIG. 1 includes all the elements from the light blocking film 220 to the common electrode 280 which are sequentially formed.

On the pixel electrode 180 of the first panel 100 is formed the first alignment layer 310; and on the common electrode 280 of the second panel 200 is formed the second alignment layer 320. Between the first alignment layer 310 and the second alignment layer 320 is arranged the liquid crystal layer 300.

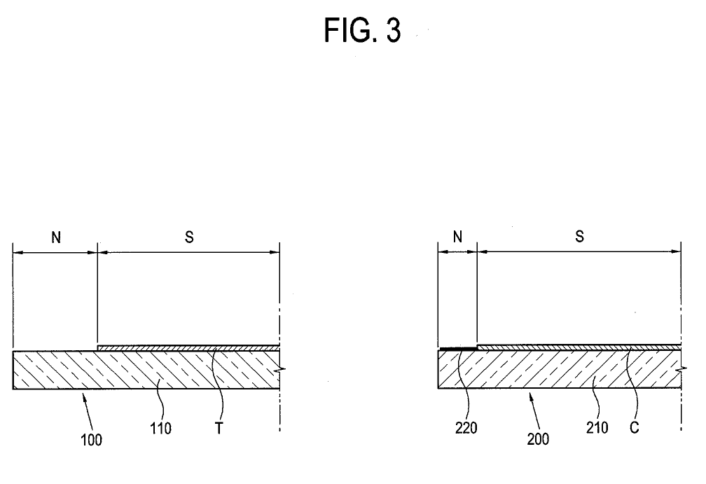

Hereinafter, a manufacturing method of the display panel assembly 50 according to a second exemplary embodiment of the present invention will be described with reference to FIGS. 3 to 7.

Firstly, as shown in FIG. 3, the first panel 100 and the second panel 200 each having the display area S and the non-display area N are prepared.

The first panel 100 includes the first substrate member 110 and the first thin film forming layer T. The first thin film forming layer T includes the TFT and the pixel electrode.

The second panel 200 includes the second substrate member 210 and the second thin film forming layer C. The second thin film forming layer C includes the common electrode.

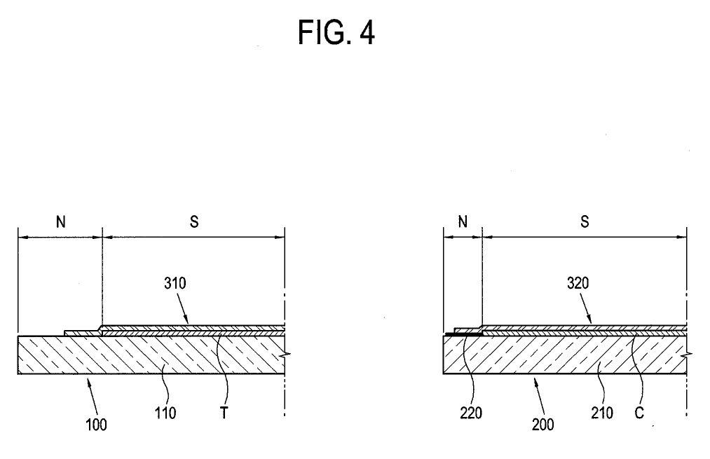

Next, as shown in FIG. 4, the first alignment layer 310 and the second alignment layer 320 are formed on the first panel 100 and the second panel 200, respectively. The first alignment layer 310 and the second alignment layer 320 are formed not only on the display area S but also on the non-display area N.

The first alignment layer 310 and the second alignment layer 320 may be formed by various methods known in the art. For example, the first alignment layer 310 and the second alignment layer 320 can be formed by coating an alignment material on the first panel 100 and the second panel 200 and then rubbing the coated alignment material. The first and second alignment layers 310 and 320 may be formed of at least one of an organic material and an inorganic material.

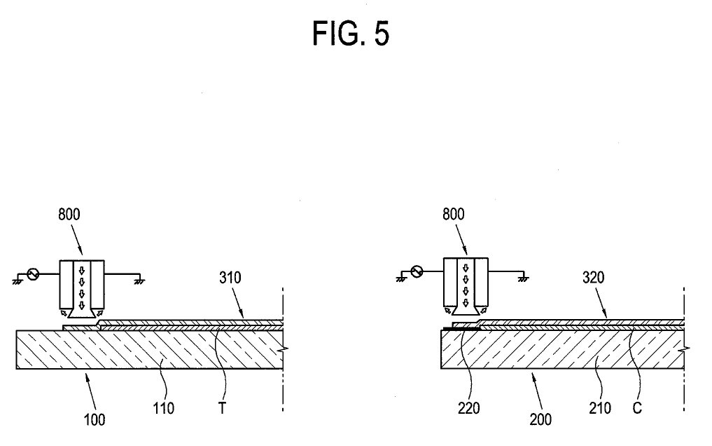

Next, as shown in FIG. 5, parts of the first and second alignment layers 310 and 320 which are disposed on the non-display areas N of the first and second panels 100 and 200 are eliminated, respectively, by means of a spot-etching atmospheric plasma device 800. For example, a Diamond-Like Carbon (DLC) film eliminator of Japanese Sekisui Chemical Co., Ltd. may be used as the spot-etching atmospheric plasma device 800. It has been experimentally found that the DLC film eliminator is generally used for spot-etching of an inorganic film but is also effective for eliminating an alignment layer of an organic material.

The spot-etching atmospheric plasma device 800 can etch an arbitrary local area into a width of several millimeters, and thus, can effectively and selectively eliminate the parts of the first and second alignment layers 310 and 320 on the non-display areas N. Further, since the etching is locally performed, there is little possibility that defects are generated at other parts of the first and second alignment layers 310 and 320 during eliminating the first and second alignment layers 310 and 320.

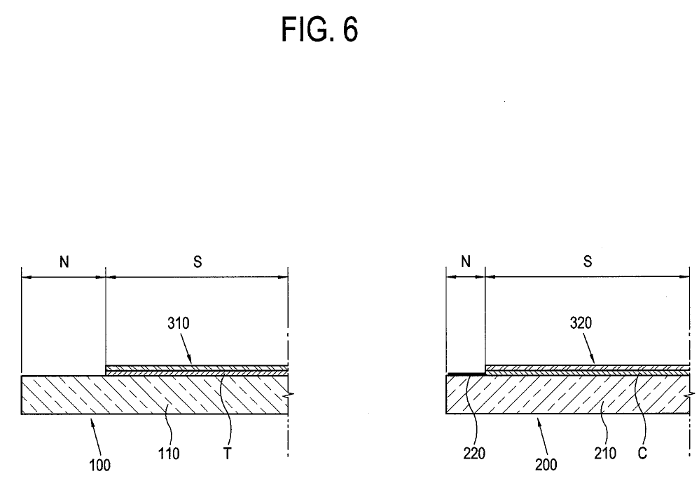

In this way, substantially all the parts of the first and second alignment layers 310 and 320 on the non-display areas N are eliminated, as shown in FIG. 6. However, the present invention is not limited thereto. For example, all the parts of the first and second alignment layers 310 and 320 should not be necessarily eliminated, but a very small part of the first and second alignment layers 310 and 320 may remain on the non-display areas N. In this case, the first and second alignment layers 310 and 320 do not enter into a region of the non-display areas N on which the sealant 350 is to be formed.

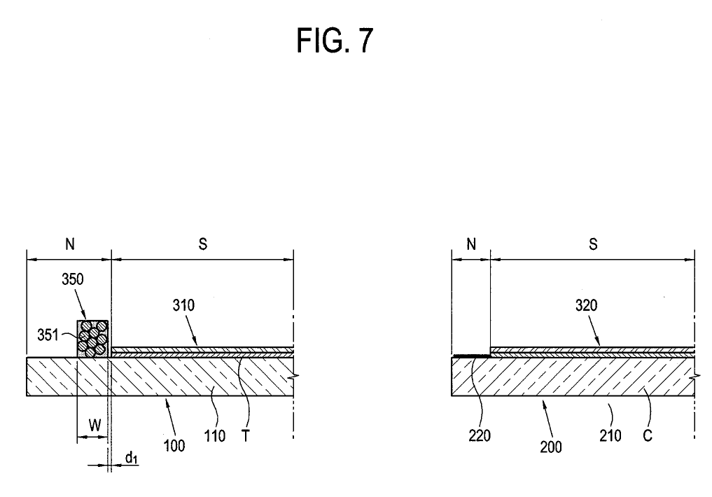

Next, as shown in FIG. 7, the sealant 350 is formed on the non-display area N of the first panel 100. Alternatively, the sealant 350 may be formed on the non-display area N of the second panel 200.

The sealant 350 has the width W of 0.5-1.5 mm. This width is determined so that the size of the non-display area N can be minimized while stably maintaining an adhesive force of the sealant 350.

The sealant 350 is arranged to be spaced from the edge of the display area S by the distance d1 of 0.1-1.0 mm. As described above, if the distance d1 is smaller than 0.1 mm, the sealant 350 is likely to overlap with the first and second alignment layers 310 and 320. Also, it is desirable that the distance d1 is not less than 0.1 mm considering that the sealant 350 may enter into the display area S during the process of forming the sealant 350. To the contrary, if the distance d1 is larger than 1.0 mm, the non-display area N becomes large more than necessary.

The sealant 350 is made of a conductive material. The sealant 350 may include a plurality of conductive balls. The sealant 350 is connected with the common electrode 280 of the second panel 200. That is, the common electrode 280 is applied the common voltage through the sealant 350. Accordingly, an additional element to supply the common voltage to the common electrode 280 is unnecessary. Thus, the non-display area N can be further minimized.

Next, the first and second panels 100 and 200 are adhered each other, with the first and second alignment layers 310 and 320 facing each other, to form the display panel assembly 50 as shown in FIG. 1.

Then, although not shown, the processes of forming the liquid crystal layer 300 between the first and second alignment layers 310 and 320 and cutting edges of the first and second panels 100 and 200 may be further performed.

The sealant 350 is spaced from the edge of the second panel 200 by the distance d2 of 0.1-0.3 mm and from the edge of the first panel 100 by the distance d3 of 1.0-1.5 mm. Here, the distance d3 between the edge of the first panel 100 and the sealant 350 may be substantially the same as the distance d2 between the edge of the second panel 200 and the sealant 350, in a part of the edge of the first panel 100 where the drive printed circuit board is not connected. In this case, the distance d3 is 0.1-0.3 mm like the distance d2.

In this way, the display panel assembly 50 having a non-display area N minimized in size in comparison with a display area S can be provided.

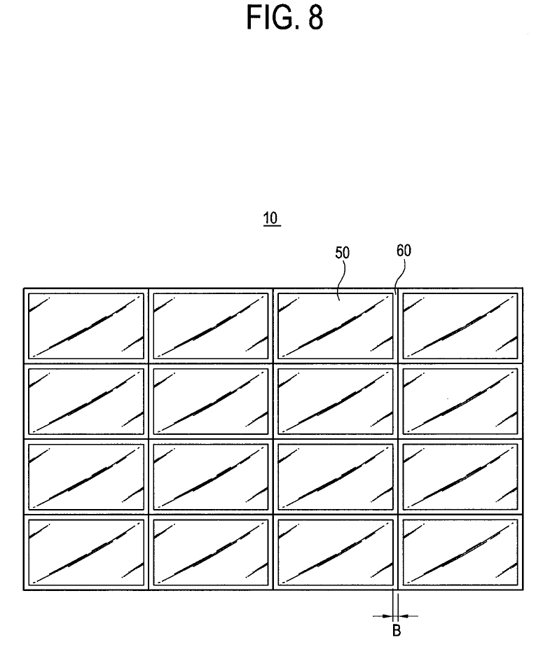

Hereinafter, a display device 10 according to a third exemplary embodiment of the present invention will be described with reference to FIG. 8. The display device 10 includes the display panel assembly 50.

As shown in FIG. 8, the display device 10 includes the plurality of display panel assemblies 50 and a support 60 which supports the plurality of display panel assemblies 50 to be aligned and connected each other. Although not shown, the display device 10 further includes a backlight unit which supplies light to each display panel assembly 50. The display device 10 may include various types of backlight units known in the art.

The plurality of display panel assemblies 50 may form a single extra large-sized image or a plurality of video images corresponding to the plurality of display panel assemblies 50.

The display panel assembly 50 is the one according to first exemplary embodiment of the present invention, which has the minimized non-display area N in comparison with the display area S, as described with reference to FIG. 1.

The support 60 covers the non-display area N of the display panel assembly 50. Accordingly, a part B of the display panel assembly 50 which is covered by the support 60 can be minimized.

With this configuration, when the display device 10 including the plurality of display panel assemblies 50 displays a single extra large-sized image, lowering of the preciseness and completeness of the image due to the non-display area N at the boundary of the adjacent display panel assemblies 50 can be reduced.

As described above, according to the present invention, there is provided a display panel assembly which has a minimized non-display area in comparison with a display area. That is, an alignment layer is eliminated from the non-display area, and thus, a sealant can be disposed as close to the display area as possible, thereby decreasing the non-display area necessary for the sealant.

Further, an additional element to apply a common voltage to a common electrode can be omitted through a conductive sealant. Accordingly, the non-display area can be significantly decreased.

Also, according to the present invention, there is provided a manufacturing method of the display panel assembly which has the minimized non-display area in comparison with the display area.

Also, according to the present invention, there is provided a display device which has the plurality of display panel assemblies to display a single extra large-sized image, each display panel assembly having the minimized non-display area in comparison with the display area. In this case, lowering of the preciseness and completeness of the image due to the non-display area at the boundary of the adjacent display panel assemblies can be reduced.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A manufacturing method of a display panel assembly, comprising:
preparing a first panel and a second panel each having a display area and a non-display area;
forming a first alignment layer and a second alignment layer on the first panel and the second panel, respectively;
eliminating at least a part of the first alignment layer and the second alignment layer which is disposed on the non-display area;
forming a sealant on the non-display area of at least one of the first panel and the second panel; and
adhering the first panel and the second panel each other with the first alignment layer and the second alignment layer facing each other.

2. The method according to claim 1, wherein the sealant is spaced from the first alignment layer and the second alignment layer.

3. The method according to claim 2, wherein the sealant has a width of 0.5-1.5 mm.

4. The method according to claim 2, wherein the sealant is spaced from the display area by a distance 0.1-1.0 mm.

5. The method according to claim 2, wherein the sealant is spaced from relatively close one of an edge of the first panel and an edge of the second panel by a distance 0.1-0.3 mm.

6. The method according to claim 5, wherein the sealant is spaced from relatively distant one of the edge of the first panel and the edge of the second panel by a distance 1.0-1.5 mm.

7. The method according to claim 1, wherein the first alignment layer and the second alignment layer are eliminated using a spot-etching atmospheric plasma device.

8. The method according to claim 1, wherein substantially all the first alignment layer and the second alignment layer are eliminated from the non-display area.

9. The method according to claim 1, wherein the sealant comprises a conductive material.

10. A display panel assembly which has a display area and a non-display area around the display, comprising:
a first panel which comprises a thin film transistor and a pixel electrode;
a second panel which comprises a common electrode and is arranged opposite to the first panel;
a first alignment layer which is formed on a surface of the first panel facing the second panel;
a second alignment layer which is formed on a surface of the second panel facing the first panel;
a liquid crystal layer which is disposed between the first panel and the second panel; and
a sealant which is arranged on the non-display area to surround the display area and adheres the first panel and the second panel each other,
wherein at least a part of the first alignment layer and the second alignment layer is eliminated from the non-display area.

11. The display panel assembly according to claim 10, wherein the sealant is spaced from the first alignment layer and the second alignment layer.

12. The display panel assembly according to claim 11, wherein the sealant has a width of 0.5-1.5 mm.

13. The display panel assembly according to claim 11, wherein the sealant is spaced from the display area by a distance of 0.1-1.0 mm.

14. The display panel assembly according to claim 10, wherein substantially all the first alignment layer and the second alignment layer are eliminated from the non-display area.

15. The display panel assembly according to claim 10, wherein the sealant comprises a conductive material.

16. The display panel assembly according to claim 15, wherein the sealant comprises a conductive ball, and the sealant is electrically connected with the common electrode of the second panel.

17. A display device comprising:
a plurality of display panel assemblies each having a display area through which an image is displayed and a non-display area around the display area; and
a support which supports the plurality of display panel assemblies to be aligned and connected each other,
wherein each display panel assembly comprising:
a first panel which comprises a thin film transistor and a pixel electrode;
a second panel which comprises a common electrode and is arranged opposite to the first panel;
a first alignment layer which is formed on a surface of the first panel facing the second panel;
a second alignment layer which is formed on a surface of the second panel facing the first panel;
an liquid crystal layer which is disposed between the first panel and the second panel; and
a sealant which is arranged on the non-display area to surround the display area and adheres the first panel and the second panel each other,
wherein at least a part of the first alignment layer and the second alignment layer is eliminated from the non-display.

18. The display device according to claim 17, wherein the sealant is spaced from the first alignment layer and the second alignment layer.

19. The display device according to claim 17, wherein substantially all the first alignment layer and the second alignment layer are eliminated from the non-display area.

20. The display device according to claim 17, wherein the sealant comprises a conductive material.
